(19) United States
(12) Patent Application Publication
(10) Pub. No.: US 2024/0346215 A1
(43) Pub. Date: Oct. 17, 2024

(54) METHOD FOR DESIGNING PARAMETERS OF AN ADVANCE STRESS RELIEF HOLE IN A ROCKBURST SOURCE ZONE OF A CONSTRUCTION TUNNEL IN DEEP-SEATED HARD ROCKS

(71) Applicant: Institute of Rock and Soil Mechanics, Chinese Academy of Sciences, Wuhan (CN)

(72) Inventors: Shili QIU, Wuhan (CN); Shaojun LI, Wuhan (CN); Zhenkun XIE, Wuhan (CN); Quan JIANG, Wuhan (CN); Dingping XU, Wuhan (CN); Hong ZHENG, Wuhan (CN)

(73) Assignee: Institute of Rock and Soil Mechanics, Chinese Academy of Sciences, Wuhan (CN)

(21) Appl. No.: 18/597,869

(22) Filed: Mar. 6, 2024

(30) Foreign Application Priority Data
Apr. 17, 2023 (CN) 202310406355X

(51) Int. Cl. G06F 30/28; E21D 9/00; E21F 17/00

(52) U.S. Cl. CPC G06F 30/28; E21D 9/003; E21F 17/00

(57) ABSTRACT

Disclosed is a method for designing parameters of an advance stress relief hole in a rockburst source zone of a construction tunnel in deep-seated hard rocks, including S1: classifying rockbursts in the TBM tunnel in the deep-seated hard rocks; S2: identifying a potential rockburst source zone of the TBM tunnel in the deep-seated hard rocks; S3: developing a scheme design and effect evaluation method for the parameters of the advance stress relief hole; S4: performing analysis to find a pattern in the parameters of the advance stress relief hole and optimizing the design; and S5: determining an optimal scheme for arranging the stress relief hole in accord with engineering practice.

### CROSS-REFERENCE TO RELATED APPLICATIONS

The application claims priority to Chinese patent application No. 202310406355X, filed on Apr. 17, 2023, the entire contents of which are incorporated herein by reference.

### TECHNICAL FIELD

The present application relates to the technical field of tunnel construction, and in particular, to a method for designing parameters of an advance stress relief hole in a rockburst source zone of a construction tunnel in deep-seated hard rocks.

### BACKGROUND

TBM tunneling in deep-seated hard rocks breaks the primitive stress equilibrium of the rock mass, causing the concentration of enormous amounts of elastic strain energy within a certain depth range of rocks surrounding the tunnel, and applying an advance stress relief hole in this energy concentration area for stress relief is usually considered an important way to control a strong strain rockburst. However, as the cutter-head structure of a TBM limits the stress relief hole to be applied only in a limited space behind the cutter-head, the effectiveness of such a stress relief hole is questioned, and the lack of scientific design methods also leads to a lack of understanding of the “stress relief and energy dissipation mechanism” of the stress relief hole, thus significantly limiting the scientific application of the advance stress relief hole technology in TBM tunnels.

### SUMMARY

To solve the foregoing problem, embodiments of the present application provide a method for designing parameters of an advance stress relief hole in a rockburst source zone of a construction tunnel in deep-seated hard rocks, which solves the challenge in engineering practice that values of parameters of an advance stress relief hole are often selected based on experience due to a lack of reliable analytical means. The technical solution is as follows:

The present application provides a method for designing parameters of an advance stress relief hole in a rockburst source zone of a construction tunnel in deep-seated hard rocks, comprising S1: classifying rockbursts in the TBM tunnel in the deep-seated hard rocks: to be specific, collecting statistical information along the tunnel, estimating the rockbursts along the TBM tunnel, and determining rockburst risk zones of each level along the tunnel; S2: identifying a potential rockburst source zone of the TBM tunnel in the deep-seated hard rocks: to be specific, accurately identifying, based on in-situ monitoring and laboratory simulation results, a potential high geo-stress and high elastic energy concentration area in surrounding rock masses in the rockburst risk zones of a medium level and above obtained in the step S1; S3: developing a scheme design and effect evaluation method for the parameters of the advance stress relief hole: to be specific, preliminarily determining a scheme for arranging the advance stress relief hole based on the potential rockburst source zone obtained in the step S2, reasonably selecting a test analysis method, and establishing a matching test design scheme and indicators for evaluating stress relief and energy dissipation effects; S4: performing analysis to find a pattern in the parameters of the advance stress relief hole and optimizing the design: to be specific, obtaining numerical simulations and analyzing a simulation result of the test scheme in the step S3, and quantifying degrees to which the parameters of the advance stress relief hole affect the stress relief and energy dissipation effects and a correlation between the parameters; and S5: determining an optimal scheme for arranging the advance stress relief hole in accord with engineering practice: to be specific, determining, based on the pattern and an analysis result obtained in the step S4, the optimal scheme for arranging the advance stress relief hole in accord with engineering practice, and conducting validation.

For example, in the method for designing parameters of an advance stress relief hole in a rockburst source zone of a construction tunnel in deep-seated hard rocks provided in an embodiment, in the step S1, the statistical information along the tunnel comprises engineering geological conditions and geo-stress conditions of engineering areas along the tunnel, and construction design parameters such as a burial depth and an excavation diameter of the tunnel.

For example, in the method for designing parameters of an advance stress relief hole in a rockburst source zone of a construction tunnel in deep-seated hard rocks provided in an embodiment, in the step S2, means for the in-situ monitoring comprises stress monitoring such as hydraulic fracturing or disturbed stress testing, micro-seismic monitoring, and acoustic emission monitoring.

For example, in the method for designing parameters of an advance stress relief hole in a rockburst source zone of a construction tunnel in deep-seated hard rocks provided in an embodiment, in the step S3, the test analysis method comprises a comprehensive test method, a single-variable test method, and an orthogonal test method, a numerical simulation method used during the analysis is a finite difference method, and a constitutive model of a simulation unit is an elastoplastic constitutive model; the test design scheme comprises parameter design and scheme design; and the indicators for evaluating stress relief and energy dissipation effects are proposed from the perspective of stresses and elastic strain energy, and the stress relief and energy dissipation effects of the advance stress relief hole are directly or indirectly shown based on changes in the test indicators before and after the advance stress relief hole is applied.

For example, in the method for designing parameters of an advance stress relief hole in a rockburst source zone of a construction tunnel in deep-seated hard rocks provided in an embodiment, the parameters are classified into geometric parameters of the hole and a parameter of a distance between holes, wherein the parameter of the distance between holes in the TBM construction tunnel is reasonably designed based on a stress relief area and expected stress relief effect, and the stress relief hole is arranged through parallel arrangement or distributed arrangement.

For example, in the method for designing parameters of an advance stress relief hole in a rockburst source zone of a construction tunnel in deep-seated hard rocks provided in an embodiment, the scheme design comprises design of a variation range of each of the parameters of the hole and design of a combination scheme of the parameters of the hole.

For example, in the method for designing parameters of an advance stress relief hole in a rockburst source zone of a construction tunnel in deep-seated hard rocks provided in an embodiment, when the indicators for evaluating stress relief and energy dissipation effects are proposed from the perspective of stresses, they are proposed from the perspective of maximum principal stress and an average maximum principal stress relief rate among key stress relief points of the stress relief hole is calculated according to the following formulas 1 and 2, wherein the key points are located at midpoints on an arc connecting two adjacent drill holes on a side of each monitoring section:

$${ϕ}^{i} = \frac{{σ}_{before}^{i} - {σ}_{after}^{i}}{{σ}_{before}^{i}} \times 100 \% ; and \qquad Formula 1$$

$$Φ = \frac{{\sum }_{i = 1}^{n} {ϕ}^{i}}{n} , \qquad Formula 2$$

wherein ϕⁱ is a maximum principal stress relief rate at a single monitoring point, Φ is the average maximum principal stress relief rate among all monitoring points, σ_{before}ⁱ is a value, measured in Pa, of maximum principal stress at an i^{th} monitoring point before drilling, σ_{after}ⁱ is a value, measured in Pa, of maximum principal stress at the i^{th} monitoring point after drilling, and n is quantity of monitoring points.

For example, in the method for designing parameters of an advance stress relief hole in a rockburst source zone of a construction tunnel in deep-seated hard rocks provided in an embodiment, when the indicators for evaluating stress relief and energy dissipation effects are proposed from the perspective of elastic strain energy, energy per unit volume relieved by a key stress relief area of the stress relief hole is calculated according to the following formulas 3 and 4, wherein the key stress relief area is determined based on positions of axes of inside and outside stress relief holes, and extends only to a position as far as two times a diameter of the advance stress relief hole from a wall of the advance stress relief hole:

$${π}^{i} = \frac{{σ}_{1}^{2} + {σ}_{2}^{2} + {σ}_{3}^{2} - 2 v ( {σ}_{1} {σ}_{2} + {σ}_{2} {σ}_{3} + {σ}_{1} {σ}_{3} )}{2 E} ; and \qquad Formula 3$$

$$Π = \frac{{\sum }_{i = 1}^{n} [ ( {π}_{before}^{i} - {π}_{after}^{i} ) * {V}_{i} ]}{V} , \qquad Formula 4$$

wherein πⁱ is a value, measured in J/m³, of elastic strain energy per unit volume of an i^{th} unit, Π is energy per unit volume, measured in J/m³, relieved by an energy calculation area, σ₁, σ₂, and σ₃, measured in Pa, are respectively maximum principal stress, intermediate principal stress, and minimum principal stress at a centroid of the unit, ν and E, measured in Pa, are respectively a Poisson ratio and a modulus of elasticity of the unit, π_{before}ⁱ is an elastic strain energy density, measured in J/m³, of the i^{th} unit after drilling, π_{after}ⁱ is an elastic strain energy density, measured in J/m³, of the i^{th} unit before drilling, Vᵢ is a volume, measured in m³, of the i^{th} unit, n is quantity of units involved in the calculation, and V is a sum of unit volumes, measured in m³, involved in the calculation.

For example, in the method for designing parameters of an advance stress relief hole in a rockburst source zone of a construction tunnel in deep-seated hard rocks provided in an embodiment, in the step S4, content of the analysis to find a pattern in the parameters of the advance stress relief hole comprises correlation analysis and sensitivity analysis.

For example, in the method for designing parameters of an advance stress relief hole in a rockburst source zone of a construction tunnel in deep-seated hard rocks provided in an embodiment, in the step S5, content of the validation comprises estimating the stress relief effect in a case of optimal arrangement of the stress relief hole by using the numerical simulation method in the step S4, and comparing the stress relief effect with that given in each test design scheme during test scheme design in the step S3, to validate the optimal scheme for arranging the stress relief hole and validate a conclusion obtained through pattern analysis.

The method for designing parameters of an advance stress relief hole in a rockburst source zone of a construction tunnel in deep-seated hard rocks provided in some embodiments of the present application has the following beneficial effects: the method according to the present application, with the objective of optimizing relief of high stresses and high elastic strain energy in rock masses in a rockburst source zone of a TBM tunnel, provides an advance stress relief hole design scheme and analyzes a pattern in parameters of an advance stress relief hole and stress relief effect to obtain optimal parameters for arranging the advance stress relief hole, which solves the challenge in engineering practice that values of parameters of an advance stress relief hole are often selected based on experience due to a lack of reliable analytical means.

### BRIEF DESCRIPTION OF THE DRAWINGS

To describe technical solutions in the embodiments of the specification or in the prior art more clearly, the following briefly describes the accompanying drawings needed for describing the embodiments. Apparently, the accompanying drawings in the following description show merely some embodiments of the present application, and those of ordinary skill in the art may further derive other accompanying drawings from these accompanying drawings without creative efforts.

FIGS. 1A and 1B is a flowchart of a method for designing according to the present application;

FIG. 2 is a schematic diagram of a manner of arranging an advance stress relief hole in a TBM construction tunnel in deep-seated hard rocks and a stress relief area;

FIG. 3 is a schematic diagram of parallel arrangement of an advance stress relief hole in a TBM construction tunnel in deep-seated hard rocks;

FIG. 4 is a schematic diagram of distributed arrangement of an advance stress relief hole in a TBM construction tunnel in deep-seated hard rocks;

FIG. 5 is a schematic diagram of a cross section in a scheme for designing parameters of an advance stress relief hole in a TBM construction tunnel in deep-seated hard rocks;

FIG. 6 is a schematic diagram of a horizontal section in a scheme for designing parameters of an advance stress relief hole in a TBM construction tunnel in deep-seated hard rocks;

FIG. 7 is a schematic diagram of a cross section at a point for monitoring an average stress relief rate of an advance stress relief hole in a TBM construction tunnel in deep-seated hard rocks;

FIG. 8 is a schematic diagram of a horizontal section at a point for monitoring an average stress relief rate of an advance stress relief hole in a TBM construction tunnel in deep-seated hard rocks;

FIG. 9 is a schematic diagram of a cross section in an area for monitoring energy per unit volume relieved by an advance stress relief hole in a TBM construction tunnel in deep-seated hard rocks; and

FIG. 10 is a schematic diagram of a horizontal section in an area for monitoring energy per unit volume relieved by an advance stress relief hole in a TBM construction tunnel in deep-seated hard rocks.

Reference numbers: 1: advance stress relief hole; 2: maximum principal stress relief area; 3: maximum principal stress concentration area; 4: TBM cutter-head; 5: TBM tunneling direction; 6: TBM-tunneled area; 7: illustration of principal stress direction; 8: area to be tunneled by a TBM; 9: included angle parameter of the advance stress relief hole; 10: diameter parameter of the advance stress relief hole; 11: length parameter of the advance stress relief hole; 12: inclination angle parameter of the advance stress relief hole; 13: parameter of a distance between advance stress relief holes; 14: point for monitoring the average stress relief rate; 15: interval of 0.5 times the tunnel diameter; 16: section for monitoring the average stress relief rate; and 17: area for monitoring relieved energy per unit volume.

### DETAILED DESCRIPTION OF THE EMBODIMENTS

The technical solutions in the embodiments of the present application will be clearly and completely described below with reference to the accompanying drawings in the embodiments of the present application. Apparently, the described embodiments are merely some rather than all of the embodiments of the present application. All other embodiments obtained by a person of ordinary skill in the art based on the embodiments of the present application without creative efforts shall fall within the protection scope of the present application.

Unless otherwise defined, the technical terms or scientific terms used herein shall have the same meaning as that commonly understood by a person of ordinary skill in the art of the present application. As used herein, “first”, “second”, and the like do not indicate any sequence, quantity, or importance, but are only used to distinguish different components. As used herein, “include”, “comprise”, and the like mean that an element or item appearing before the word covers an element, an item, or an equivalent thereof listed after the word without excluding other elements or items. As used herein, “connection”, “connected”, and the like are not limited to a physical or mechanical connection but may include a direct or indirect electrical connection. As used herein, “up”, “down”, “left”, “right”, and the like are merely used to represent a relative positional relationship, and when an absolute position of a described object changes, the relative positional relationship may also change accordingly.

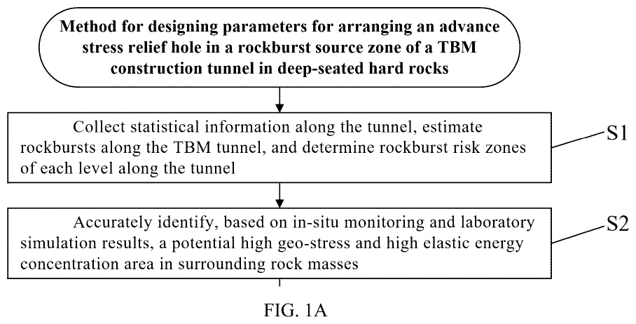

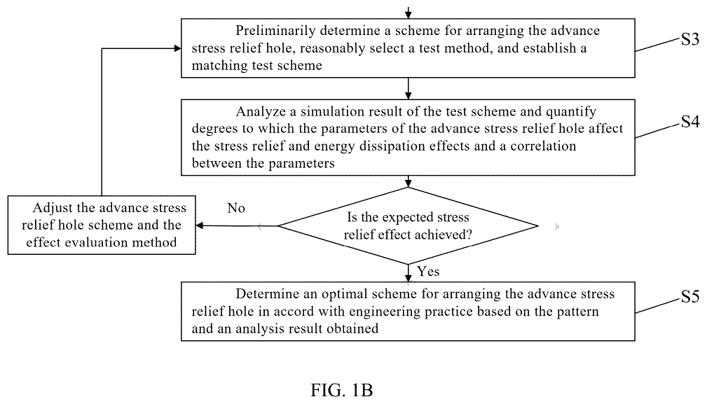

The present application provides a method for designing parameters of an advance stress relief hole in a rockburst source zone of a construction tunnel in deep-seated hard rocks. As shown in FIGS. 1A and 1B, the method includes:
S1: classifying rockbursts in the TBM tunnel in the deep-seated hard rocks: to be specific, collecting statistical information along the tunnel, estimating the rockbursts along the TBM tunnel, and determining rockburst risk zones of each level along the tunnel;

Specifically, in rock engineering with risks of rockbursts, classifying rockbursts into different levels is an important premise for designing a support structure and taking rockburst prevention and control measures. Therefore, prior to studies on a scheme for designing an advance stress relief hole in a TBM tunnel, rockbursts along the tunnel are classified into different levels based on engineering geological conditions and geo-stress conditions in an engineering area, and related construction design parameters (such as a burial depth and an excavation diameter of the tunnel). A method for classifying rockbursts may be divided into a single-factor theoretical criterion and a multi-factor theoretical criterion based on the quantity of factors used in the theoretical criterion. The single-factor theoretical criterion includes a strength theoretical criterion (Tao Zhenyu criterion, Turchaninov criterion, Russenes criterion, and the like), an energy theoretical criterion (energy relief rate), rigidity theoretical criterion (brittleness coefficient), and the like. The multi-factor criterion includes a rockburst vulnerability index (RVI), an excavation vulnerability potential (EVP), and the like. Rockbursts along the TBM tunnel are estimated to determine rockburst risk zones of each level along the tunnel so that different combinations of rockburst prevention and control measures can be taken based on different levels of rockbursts. Generally, when the engineering is not important and the collapse of the engineering structure would not cause severe consequences, advance stress relief measures are only taken in tunnel zones with potential rockbursts of a medium level or above.
S2: identifying a potential rockburst source zone of the TBM tunnel in the deep-seated hard rocks: to be specific, accurately identifying, based on in-situ monitoring and laboratory simulation results, a potential high geo-stress and high elastic energy concentration area in surrounding rock masses in the rockburst risk zones of a medium level and above obtained in the step S1;

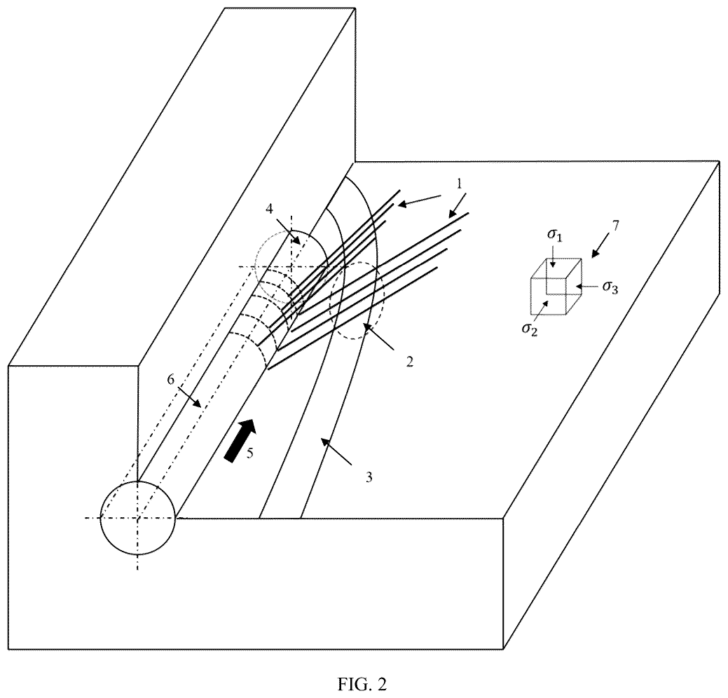

Specifically, when a TBM is tunneling in a rockburst risk zone of a medium or high level, an enormous amount of elastic strain energy is concentrated in the surrounding rocks of the tunnel under the action of a high geo-stress. When the concentrated elastic strain energy exceeds the minimum energy accumulation limit bearable by the surrounding rocks, the excess part is quickly released, causing fast ejection of rock masses around the tunnel, namely rockbursts. Therefore, to accurately identify a potential rockburst source zone in a TBM tunnel, on one hand, rockburst source zone monitoring may be performed in situ, for which stress states of surrounding rocks and positions of high stress concentration areas are obtained by means of stress monitoring (for example, hydraulic fracturing or disturbed stress testing), and positions of fractures in the surrounding rocks, values of bursting energy, and the like are obtained based on micro-seismic and acoustic emission monitoring results; on the other hand, various numerical simulation methods such as a finite element method (FEM), a finite difference method (FDM), a particle flow code (PFC), rock failure process analysis (RFPA), and discontinuous deformation analysis (DDA) may be used to obtain a mechanical response of excavation from the surrounding rocks of the tunnel and properly estimate rockburst source zones from the perspective of stresses and energy, so that a preliminary stress relief hole arrangement scheme can be established based on in-situ monitoring and a laboratory simulation result.
S3: developing a scheme design and effect evaluation method for the parameters of the advance stress relief hole: to be specific, preliminarily determining a scheme for arranging the advance stress relief hole based on the potential rockburst source zone obtained in the step S2, wherein specifically, as shown in FIG. 2, in the TBM construction tunnel in the deep-seated hard rocks, if the direction of maximum principal stress on surrounding rocks is the direction of maximum, intermediate, or minimum principal stress shown in the illustration 7 of principal stress direction, when the TBM is tunneling in the direction represented by 5, a maximum principal stress concentration area 3 is formed inside the surrounding rocks; to relieve a part of the stress on this area, an advance stress relief hole 1 is arranged within the space represented by the TBM-tunneled area 6 to form a maximum principal stress relief area 2, so as to preliminarily determine a position, angle, and depth at which the advance stress relief hole is arranged, and thereby reasonably selecting a test analysis method, and establishing a matching test design scheme and indicators for evaluating stress relief and energy dissipation effects.

For the test analysis method, common parameter pattern analysis methods include a comprehensive test method, a single-variable test method, an orthogonal test method, and the like. A numerical simulation method used during the analysis is a finite difference method, and a constitutive model of a simulation unit is an elastoplastic constitutive model.

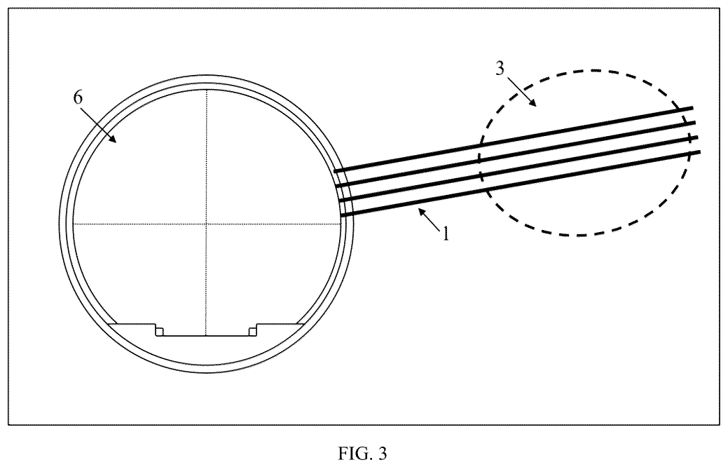

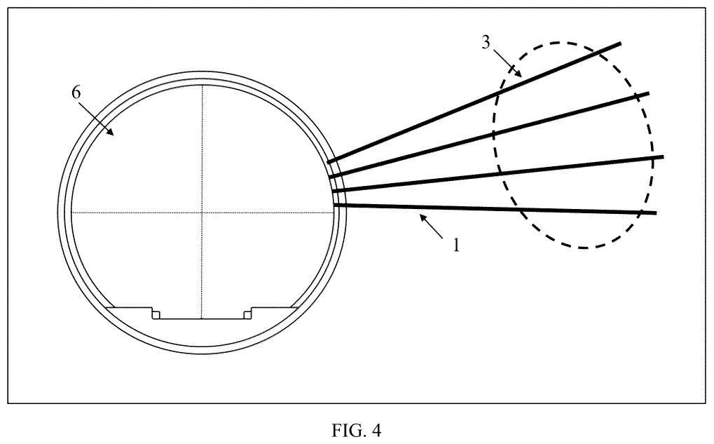

The test design scheme includes parameter design and scheme design. The parameters are classified into geometric parameters of the hole and a parameter of a distance between holes. The geometric parameters of the hole are subject to related drilling machinery in situ for the stress relief hole and engineering requirements and include diameter and depth parameters. The parameter of the distance between holes in the TBM construction tunnel can be reasonably designed based on a stress relief area and expected relief effect in the TBM construction tunnel, and the stress relief hole is arranged through parallel arrangement shown in FIG. 3 or distributed arrangement shown in FIG. 4.

The parallel arrangement is applicable to cases in which rockburst source zones are small with a high stress relief requirement. As shown in FIG. 3, advance stress relief holes 1 are arranged parallel to each other within the TBM-tunneled area 6 in the TBM construction tunnel to run across the relatively small maximum principal stress concentration area 3. The distributed arrangement is more applicable to cases in which rockburst source zones are large with a low relief effect requirement. As shown in FIG. 4, advance stress relief holes 1 are arranged in a distributed manner within the TBM-tunneled area 6 in the TBM construction tunnel so that the relief area overlaps the relatively large maximum principal stress concentration area 3 to a higher degree.

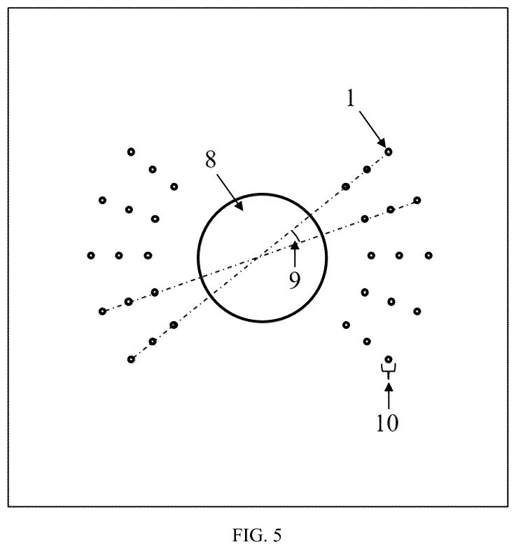

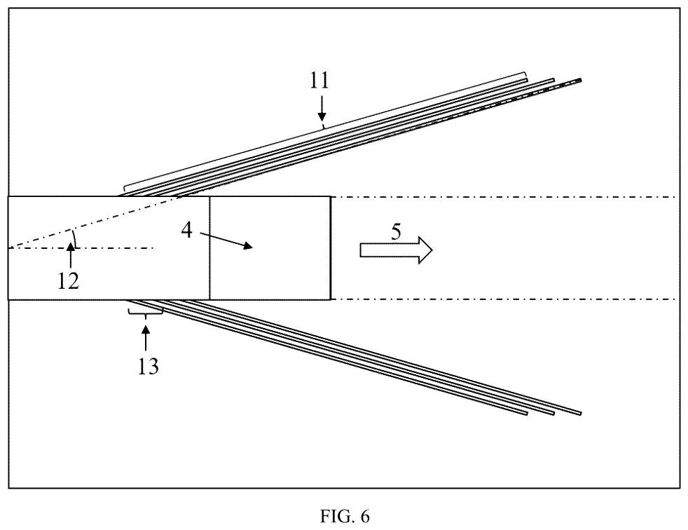

Then, the types of parameters of the hole that need to be designed are determined based on different manners of arrangement. FIGS. 5 and 6 provide parameter design examples with the distributed arrangement. A total of 5 parameters of the advance stress relief hole 1 are designed. FIG. 5 shows a parameter 9 of the included angle between advance stress relief holes 1 with distributed arrangement and a diameter parameter 10 of the advance stress relief hole in an area 8. FIG. 6 shows a length parameter 11 of the advance stress relief hole, an inclination angle parameter 12 of the advance stress relief hole, and a parameter 13 of a distance between advance stress relief holes in different rows when the advance stress relief hole 1 is drilled in the TBM tunneling direction 5 into a side wall in the TBM-tunneled area 6.

The scheme design includes design of a variation range of each of the parameters of the hole and design of a combination scheme of the parameters of the hole. In the design of the variation range of each of the parameters of the hole, a space geometry relationship between the parameters needs to be considered to prevent intersection or overlapping of stress relief holes, and a spatial relationship between the parameters of the hole and a target stress relief area also needs to be considered to ensure that a relief area of the stress relief hole overlaps the target stress relief area to a large degree. The design of the combination scheme of the parameters of the hole needs to be determined according to a selected parameter pattern analysis method. For a comprehensive test method, all possible hole parameter combination schemes need to be designed; for a single-variable test method, a hole parameter combination scheme with a specific factor changed but other parameters unchanged needs to be designed; and for an orthogonal test method, different hole parameter combination schemes need to be designed based on an orthogonal array.

The indicators for evaluating stress relief and energy dissipation effects may be proposed from the perspective of stresses and elastic strain energy. The stress relief and energy dissipation effects of the advance stress relief hole are directly or indirectly shown based on changes in the test indicators before and after the advance stress relief hole is applied.

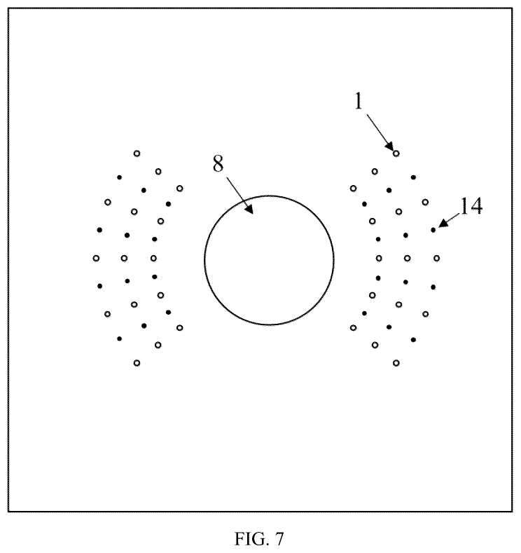

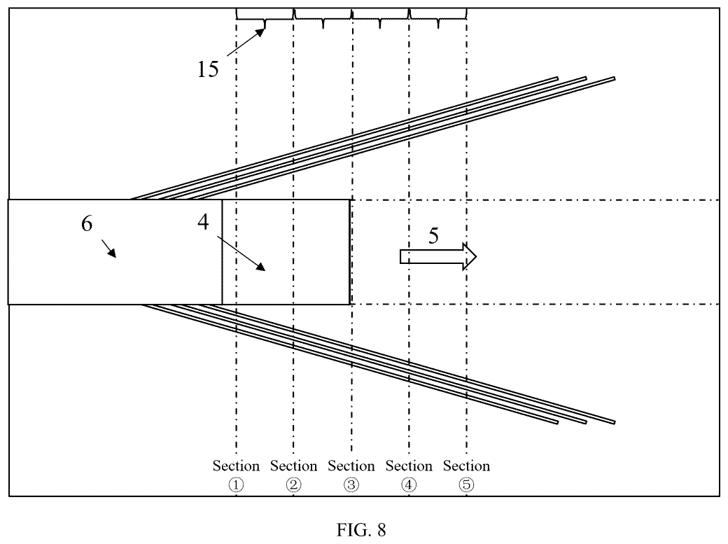

When the indicators for evaluating stress relief and energy dissipation effects are proposed from the perspective of stresses, they are proposed from the perspective of fmaximum principal stress and an average maximum principal stress relief rate among key stress relief points of the stress relief hole is calculated according to the following formulas 1 and 2. In FIGS. 7 and 8, points at which the average stress relief rate is calculated are shown from cross-sectional and horizontal-sectional perspectives. FIG. 8 shows that in the TBM tunneling direction 5, five monitoring sections are set at an interval 15 of 0.5 times the tunnel diameter based on the tunnel radius and the position of the TBM cutter-head 4. FIG. 7 shows that in the section including the area 8 to be tunneled by a TBM, a midpoint on an arc connecting two adjacent advance stress relief holes 1 on a side of the section is set as a point 14 for monitoring the average stress relief rate. The average maximum principal stress relief rate is calculated according to the following formulas 1 and 2.

$${ϕ}^{i} = \frac{{σ}_{before}^{i} - {σ}_{after}^{i}}{{σ}_{before}^{i}} \times 100 \% ; and \qquad Formula 1$$

$$Φ = \frac{{\sum }_{i = 1}^{n} {ϕ}^{i}}{n} , \qquad Formula 2$$

wherein ϕⁱ is a maximum principal stress relief rate at a single monitoring point, Φ is the average maximum principal stress relief rate among all monitoring points, σ_{before}ⁱ is a value, measured in Pa, of maximum principal stress at an i^{th} monitoring point before drilling, σ_{after}ⁱ is a value, measured in Pa, of maximum principal stress at the i^{th} monitoring point after drilling, and n is quantity of monitoring points.

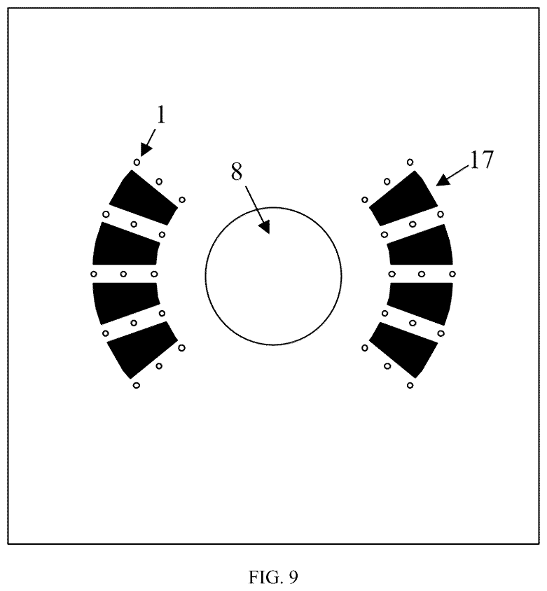

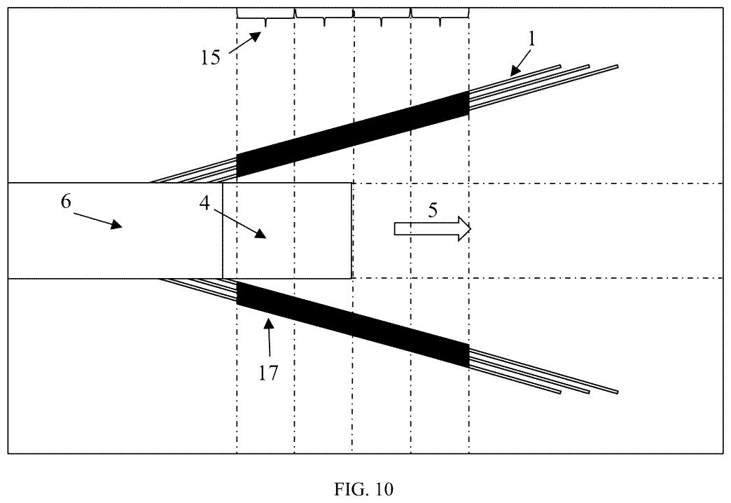

When the indicators for evaluating stress relief and energy dissipation effects are proposed from the perspective of elastic strain energy, energy per unit volume relieved by a key stress relief area of the stress relief hole shown in FIGS. 9 and 10 is calculated according to the following formulas 3 and 4. FIGS. 9 and 10 show areas for calculating the relieved energy per unit volume from cross-sectional and horizontal-sectional perspectives. FIG. 10 shows that in the TBM tunneling direction 5, four areas 17 for monitoring the relieved energy per unit volume are set at an interval 15 of 0.5 times the tunnel diameter based on the tunnel radius and distributed along the advance stress relief holes 1. It can be seen from the section including the area 8 to be tunneled by a TBM shown in FIG. 9 that each area is determined based on positions of axes of inside and outside advance stress relief holes 1 and extends to a position as far as two times a diameter of the advance stress relief hole from a wall of the advance stress relief hole to mark off the area 17 for monitoring the relieved energy per unit volume:

$${π}^{i} = \frac{{σ}_{1}^{2} + {σ}_{2}^{2} + {σ}_{3}^{2} - 2 v ( {σ}_{1} {σ}_{2} + {σ}_{2} {σ}_{3} + {σ}_{1} {σ}_{3} )}{2 E} ; and \qquad Formula 3$$

$$Π = \frac{{\sum }_{i = 1}^{n} [ ( {π}_{before}^{i} - {π}_{after}^{i} ) * {V}_{i} ]}{V} , \qquad Formula 4$$

wherein πⁱ is a value, measured in J/m3, of elastic strain energy per unit volume of an ith unit, Π is energy per unit volume, measured in J/m³, relieved by an energy calculation area, σ₁, σ₂, and σ₃, measured in Pa, are respectively maximum principal stress, intermediate principal stress, and minimum principal stress at a centroid of the unit, ν and E, measured in Pa, are respectively a Poisson ratio and a modulus of elasticity of the unit, π_{before}ⁱ is an elastic strain energy density, measured in J/m³, of the i^{th} unit after drilling, π_{after}ⁱ is an elastic strain energy density, measured in J/m³, of the i^{th} unit before drilling, Vᵢ is a volume, measured in m³, of the i^{th} unit, n is quantity of units involved in the calculation, and V is a sum of unit volumes, measured in m³, involved in the calculation.
S4: performing analysis to find a pattern in the parameters of the advance stress relief hole and optimizing the design: to be specific, obtaining numerical simulations and analyzing a simulation result of the test scheme in the step S3, and quantifying degrees to which the parameters of the advance stress relief hole affect the stress relief and energy dissipation effects and a correlation between the parameters.

Specifically, for a particular TBM tunneling machinery structure and a rockburst development condition, the degrees to which the parameters of the stress relief hole affect the stress relief and energy dissipation effects and the correlation between the parameters are quantified, so that the most predominant parameters of the hole can be preferably selected and controlled.

After the stress relief effect in different test schemes is obtained through analysis, patterns in the indicators according to each test scheme are analyzed for the research method used. The analysis may be performed from two aspects: (1) sensitivity analysis, mainly for analyzing a degree of sensitivity of each obtained parameter of the advance stress relief hole to the stress relief effect, so as to determine, by comparing the range size, a level of priority for adjusting the parameter of the stress relief effect; and (2) correlation analysis, mainly for analyzing a correlation between each obtained parameter of the advance stress relief hole and the stress relief effect, so as to determine, based on the correlation, a policy of optimizing and adjusting each parameter of the advance stress relief effect.
S5: determining an optimal scheme for arranging the advance stress relief hole in accord with engineering practice: to be specific, determining, based on the pattern and an analysis result obtained in the step S4, the optimal scheme for arranging the advance stress relief hole in accord with engineering practice, and conducting validation.

Specifically, the optimal scheme for arranging the stress relief hole in accord with engineering practice may be determined based on the pattern analysis result. Based on existing field research materials and test data as well as the optimal policy for arranging the stress relief hole, the stress relief effect in the case of the optimal relief hole arrangement may be preliminarily estimated by using the same numerical simulation method as used in the foregoing pattern analysis. The effect is compared with the stress relief effect in each test design scheme during the test scheme design process in the step S3 to validate the optimal scheme for arranging the stress relief hole and validate the result obtained through the pattern analysis. If there is a bias in the result or the relief effect is not as expected, the test analysis method, the test design scheme, and the indicators for evaluating stress relief and energy dissipation effects in the step S3 should be adjusted, and the steps S3, S4, and S5 should be performed again until expected relief effect is achieved.

Although the embodiments of the present application are disclosed above, the embodiments are not limited to the applications listed in the specification and the implementation means but totally can be applied to various fields to which the present application is applicable. For those skilled in the art, other modifications can be easily made. Therefore, without departing from the general concepts defined in the claims and equivalent ranges, the present application is not limited to particular details and illustrations shown and described herein.

1. A method for designing advance stress relief holes in a rockburst source zone of a construction tunnel in deep-seated hard rocks, wherein the method comprises:
S1: collecting statistical information along a tunnel boring machine (TBM) tunnel, and determining levels of rockburst risk zones along the TBM tunnel;
S2: identifying, based on in-situ monitoring and laboratory simulation results, a potential rockburst source zone in the rockburst risk zones obtained in the S1:
S3: determining parameters for arranging the advance stress relief holes based on the potential rockburst source zone obtained in the S2; and displaying stress relief and energy dissipation effects of the advance stress relief holes using a numerical simulation method based on the parameters:
S4: quantifying the stress relief and energy dissipation effects obtained in the S3 and a correlation between the parameters for arranging the advance stress relief holes; and
S5: determining a scheme for arranging the advance stress relief holes based on a quantified result obtained in the S4.

2. The method for designing advance stress relief holes in a rockburst source zone of a construction tunnel in deep-seated hard rocks according to claim 1, wherein in the S1, the statistical information along the TBM tunnel comprises engineering geological conditions and geo-stress conditions of engineering areas along the TBM tunnel, and construction design parameters including a burial depth and an excavation diameter of the TBM tunnel.

3. The method for designing advance stress relief holes in a rockburst source zone of a construction tunnel in deep-seated hard rocks according to claim 1, wherein in the S2, the in-situ monitoring comprises one or more of stress monitoring, micro-seismic monitoring, and acoustic emission monitoring.

4. The method for designing advance stress relief holes in a rockburst source zone of a construction tunnel in deep-seated hard rocks according to claim 1, wherein the parameters are classified into geometric parameters of the advance stress relief holes and a parameter of a distance between holes, wherein the parameter of the distance between holes in the TBM tunnel is designed based on a stress relief area and expected stress relief effect and the advance stress relief holes is arranged through parallel arrangement or distributed arrangement.

5. The method for designing advance stress relief holes in a rockburst source zone of a construction tunnel in deep-seated hard rocks according to claim 1, wherein the parameters comprises a design of a variation range of each of the parameters and a combination scheme of the parameters.

6. The method for designing advance stress relief holes in a rockburst source zone of a construction tunnel in deep-seated hard rocks according to claim 1, wherein displaying the stress relief and energy dissipation effects of the advance stress relief holes comprises evaluating the stress relief and energy dissipation effects from a perspective of maximum principal stress, and an average maximum principal stress relief rate among key stress relief points of the advance stress relief holes is calculated according to following formulas 1 and 2, wherein key points are located at midpoints on an arc connecting two adjacent drill holes on a side of each monitoring section:
$${∅}^{i} = \frac{{σ}_{before}^{i} - {σ}_{after}^{i}}{{σ}_{before}^{i}} \times 100 \% ; and \qquad Formula 1$$
$$Φ = \frac{{\sum }_{i = 1}^{n} {∅}^{i}}{n} , \qquad Formula 2$$
wherein øⁱ is a maximum principal stress relief rate at a single monitoring point, Φ is the average maximum principal stress relief rate among all monitoring points, σ_{before}ⁱ is a value, measured in Pa, of maximum principal stress at an i^{th} monitoring point before drilling, σ_{after}ⁱ is a value, measured in Pa, of maximum principal stress at the i^{th} monitoring point after drilling, and n is quantity of monitoring points.

7. The method for designing advance stress relief holes in a rockburst source zone of a construction tunnel in deep-seated hard rocks according to claim 1, wherein displaying the stress relief and energy dissipation effects of the advance stress relief holes comprises evaluating the stress relief and energy dissipation effects from a perspective of elastic strain energy, energy per unit volume relieved by a key stress relief area of the advance stress relief holes is calculated according to following formulas 3 and 4, wherein the key stress relief area is determined based on positions of axes of inside and outside stress relief holes, and extends only to a position as far as two times a diameter of the advance stress relief holes from a wall of the advance stress relief holes:
$${π}^{i} = \frac{{σ}_{1}^{2} + {σ}_{2}^{2} + {σ}_{3}^{2} - 2 v ( {σ}_{1} {σ}_{2} + {σ}_{2} {σ}_{3} + {σ}_{1} {σ}_{3} )}{2 E} ; and \qquad Formula 3$$
$$Π = \frac{{\sum }_{i = 1}^{n} [ ( {π}_{before}^{i} - {π}_{after}^{i} ) * {V}_{i} ]}{V} , \qquad Formula 4$$
wherein πⁱ is a value, measured in J/m³, of elastic strain energy per unit volume of an i^{th} unit, Π is energy per unit volume, measured in J/m³, relieved by an energy calculation area, σ₁, σ₂, and σ₃, measured in Pa, are respectively maximum principal stress, intermediate principal stress, and minimum principal stress at a centroid of the unit, ν and E, measured in Pa, are respectively a Poisson ratio and a modulus of elasticity of the unit, π_{before}ⁱ is an elastic strain energy density, measured in J/m³, of the i^{th} unit after drilling, π_{after}ⁱ is an elastic strain energy density, measured in J/m³, of the i^{th} unit before drilling, Vᵢ is a volume, measured in m³, of the i^{th} unit, n is quantity of units involved in the calculation, and V is a sum of unit volumes, measured in m³, involved in the calculation.

8. The method for designing advance stress relief holes in a rockburst source zone of a construction tunnel in deep-seated hard rocks according to claim 1, wherein in the S4, quantifying the stress relief and energy dissipation effects and the correlation between the parameters comprises correlation analysis and sensitivity analysis.

9. The method for designing advance stress relief holes in a rockburst source zone of a construction tunnel in deep-seated hard rocks according to claim 1, wherein in the S5, determining the scheme for arranging the advance stress relief holes comprises selecting the parameters for arranging the advance stress relief holes.
